(19) United States
(12) Patent Application Publication
(10) Pub. No.: US 2026/0300808 A1
(43) Pub. Date: Oct. 1, 2026

(54) ADAPTIVE DETERMINISM FOR GENERATIVE AI MODELS

(71) Applicant: SAP SE, Walldorf (DE)

(72) Inventor: Eduardo Antunes da Cunha, Mannheim (DE)

(73) Assignee: SAP SE, Walldorf (DE)

(21) Appl. No.: 19/092,740

(22) Filed: Mar. 27, 2025

(51) Int. Cl. G06N 20/00

(52) U.S. Cl. CPC G06N 20/00

(57) ABSTRACT

A computer-implemented method can receive a user prompt from a user interacting with a generative artificial intelligence (AI) model; determine, in runtime, a topic of the user prompt; select, in runtime, a set of values for a plurality of hyper-parameters of the generative AI model based on the topic of the user prompt; and prompt, in runtime, the generative AI model using the user prompt while applying the set of values for the plurality of hyper-parameters of the generative AI model. The plurality of hyper-parameters controls a degree of determinism for generating responses based on the user prompt. Related systems and software for implementing the method are also disclosed.

### BACKGROUND

Generative artificial intelligence (AI) has demonstrated remarkable capabilities in generating text, images, code, and other content types. However, one persistent challenge in the field is controlling the level of determinism in AI-generated outputs. In some applications, such as legal and medical documentation, consistency and reliability are paramount, requiring the AI to generate more deterministic responses. In contrast, in creative domains like storytelling, poem generation, or brainstorming, variability and novelty are desirable, necessitating a more non-deterministic approach. Existing generative AI (GenAI) systems often rely on some hyper-parameters, such as temperature and top-k sampling, to influence output variability. However, determining the appropriate level of determinism is not straightforward, as many hyper-parameters can influence the variability of AI-generated responses. Many users, especially non-technical ones, are unfamiliar with these parameters and their effects, making manual adjustments difficult and impractical. Furthermore, even when users have some understanding of these hyper-parameters, fine-tuning them for different contexts requires repeated trial and error, leading to inefficiencies and inconsistent experiences. Thus, there is room for improvement in intelligently managing the level of determinism in AI-generated outputs based on the context of user interactions, without requiring users to have prior knowledge of AI or prompting, thereby enhancing the user experience with more contextually aligned outputs.

### BRIEF DESCRIPTION OF THE DRAWINGS

FIG. 1 depicts an example high-level framework for adaptive determinism for generative AI models.

FIG. 2 is a block diagram depicting an example computing system supporting adaptive determinism for generative AI models.

FIG. 3 is a block diagram of an example transformer model.

FIG. 4 is a flowchart illustrating an example overall method for implementing adaptive determinism for generative AI models.

FIG. 5 schematically depicts example sliders controlling the degree of determinism for different topics.

FIG. 6 is a block diagram of an example computing system in which described embodiments can be implemented.

FIG. 7 is a block diagram of an example cloud computing environment that can be used in conjunction with the technologies described herein.

### DETAILED DESCRIPTION

### Example Overview of Generative AI

Generative AI refers to a class of machine learning models capable of producing new content, such as text, images, audio, and code, based on learned patterns from training data. One popular type of generative AI model is the large language model (LLM), which can generate human-like text responses based on input prompts. These models are typically built using deep neural networks, often leveraging transformer architectures that process vast amounts of training data to learn statistical relationships between words, phrases, and contextual patterns.

During training, a generative AI model is exposed to an extensive amount of training data and learns to predict patterns and generate outputs based on statistical relationships within the data. For example, an LLM can be trained to predict the likelihood of word sequences based on prior context. In image generation models, a similar principle applies, where the model learns patterns in visual data and generates images by predicting pixel or feature distributions. The training process involves optimizing model parameters to minimize prediction errors over multiple training iterations. The learned parameters encode probabilistic associations between different elements of the training data, allowing the model to generate coherent and contextually relevant outputs when given a user prompt. Instead of retrieving predefined answers or templates, generative AI models can construct responses dynamically by selecting outputs based on learned probability distributions.

Because generative AI models operate on probabilistic principles, their outputs can exhibit varying degrees of determinism. If a model is configured to select the most probable next element at each step-whether it be a word in a text model or a pixel in an image model—it will produce highly consistent and deterministic outputs for the same input. Conversely, introducing randomness into the response generation process can lead to more diverse and creative outputs for the same prompt.

Different use cases may demand varying degrees of determinism. For example, legal and factual queries typically require consistency to ensure that responses remain accurate and reliable. If a user asks, “What is the legal minimum number of vacation days in Germany?”, the response should be highly deterministic, ensuring that the answer remains consistent and aligns with official regulations. In contrast, creative or brainstorming applications may benefit from variability. For instance, if a user asks a generative AI model to “Tell me a joke,” the response should be more non-deterministic, producing different jokes each time to enhance novelty and engagement. This variability is desirable for entertainment or idea-generation applications but would be problematic for contexts requiring precision and repeatability. These differing requirements make it challenging to configure generative AI models in a way that adapts dynamically to different contexts.

Hyper-parameters are configurable parameters that define aspects of a generative AI model's behavior during training and inference, influencing how the model learns patterns from data and generates responses. Various hyper-parameters control the balance between deterministic and probabilistic behavior of generative AI models. For example, some generative AI models use a “temperature” parameter to influence the degree of randomness in token selection: lower values make responses more deterministic by favoring higher-probability tokens, while higher values encourage more diverse responses by allowing lower-probability tokens to be chosen. Some generative AI models also use a hyper-parameter “top-k” sampling which is used to restrict selection to the k most probable tokens, limiting randomness while still introducing some variation into responses. Some other typical hyper-parameters that can affect the deterministic characteristics of generative AI models include, but are not limited to: “top-p” sampling, which dynamically adjusts the probability threshold for selecting tokens; “min_p,” which sets a minimum probability for token selection; “seed,” which ensures reproducibility by initializing the model with a fixed random state; “do_sample,” a Boolean parameter that determines whether the model should use sampling-based token selection (introducing randomness) or always select the highest probability token (making it fully deterministic); “repetition penalty,” which discourages the model from generating repetitive words, phrases, or patterns; etc.

The set of hyper-parameters affecting determinism is not universal across various generative AI models. For example, the names and/or definitions of some hyper-parameters may be model-specific. Different models may introduce or modify hyper-parameters that govern their response variability, meaning that hyper-parameter tuning strategies are often model-specific. Furthermore, many users, particularly non-technical ones, lack familiarity with these hyper-parameters and their effects, making it difficult to manually adjust them for desirable results. Even experienced users may struggle with fine-tuning hyper-parameters effectively, especially under time pressure to obtain a proper response immediately after prompting, as achieving the right balance between deterministic and non-deterministic behavior often requires trial and error. Additionally, because the optimal degree of determinism varies across different contexts and applications, manually configuring generative AI models for each use case is often highly inefficient and impractical.

The technologies described herein address many of the challenges described above by introducing a framework for dynamically adjusting the determinism of generative AI responses based on contextual factors. While LLMs are used as examples in the following descriptions, it should be understood that the disclosed technologies are broadly applicable to other types of generative AI models, including those generating images, audio, and other content.

Example Framework for Generative AI with Adaptive Determinism

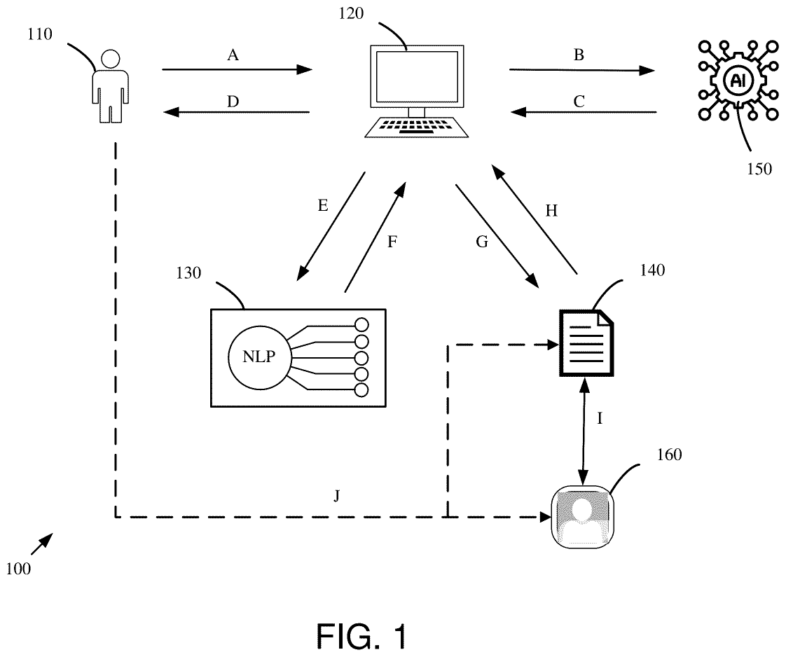

FIG. 1 illustrates an example framework for a generative AI system 100 that adaptively adjusts determinism based on the context of user interactions. As shown, the system 100 includes a generative AI agent 120, a generative AI model 150, a topic classifier 130, and a configuration file 140. In some examples, some of the system components can be combined. For instance, the topic classifier 130 and/or the configuration file 140 can be part(s) of the generative AI agent 120 in some implementations.

The generative AI agent 120 can provide a software interface between a user 110 and the generative AI model 150. For example, the user 110 can interact with the generative AI model 150 (e.g., send a prompt and receive a response) through the generative AI agent 120. As described herein, the user prompt can be presented in text, voice, or another input format. In some examples, the generative AI model 150 can be an LLM configured to generate text output. In some examples, the generative AI model 150 can be configured to generate other data formats, such as code, image, video, audio, etc. In some examples, the generative AI model 150 can be implemented using a transformer architecture, as described further below.

In some examples, the generative AI agent 120 can communicate with the generative AI model 150 via an application programming interface (API), managing API calls to send prompts and receive responses while applying appropriate hyper-parameter settings. In some examples, the API calls to the generative AI model 150 can further specify one or more hyper-parameter settings for the generative AI model 150.

As shown in FIG. 1, an administrator 160 can be responsible for maintenance of the configuration file 140. Various interactions between the user 110, the administrator 160, and components of the system 100 are represented by arrows labeled A-J, which depict the flow of information across the system 100.

In conventional approaches, the user 110 enters a user prompt (A) into the generative AI agent 120, which can directly send an API request (B) to the generative AI model 150 with the user prompt. The generative AI model 150, using a predefined or default set of hyper-parameters, can process the request and generate a response (C). The generative AI agent 120 can present the response (which can be formatted) back to the user (D). Such conventional approaches lack adaptability in controlling determinism of the generative AI model 150 since the same hyper-parameters are applied uniformly across all prompts, irrespective of the topic or context of the user prompt.

The framework disclosed herein introduces adaptive determinism, dynamically selecting hyper-parameters based on the context of the user prompt. Specifically, after the user 110 enters a user prompt (A), the generative AI agent 120 first automatically sends an API request (E) to the topic classifier 130, which can automatically determine, in runtime, the topic or category of the user prompt (F). As described herein, the topic classifier 130 can be implemented using various natural language processing (NLP) techniques, including rule-based classification, supervised machine learning models, or deep learning approaches such as transformer-based models.

In one specific example, the topic classifier 130 can be implemented using an LLM, where the generative AI agent 120 automatically generates a topic prompt and sends it to the LLM for classification. In some examples, the topic prompt can be created from a prompt template, which includes instructions for the LLM and contains one or more placeholders. In some examples, one placeholder in the prompt template can be replaced with the user prompt. In some examples, another placeholder in the prompt template can receive a list of topics defined in the configuration file 140. The topic prompt can include instructions for the LLM to classify the prompt into one appropriate topic among the list of topics.

After the topic is determined, the generative AI agent 120 can automatically query (G), in runtime, the configuration file 140 to retrieve a set of values for a plurality of hyper-parameters corresponding to the identified topic (H). The plurality of hyper-parameters and the corresponding sets of values for different topics can be predefined by the administrator 160. These hyper-parameters can be specific to the generative AI model 150 and control a degree of determinism for generating responses based on the user prompt.

The configuration file 140 can store domain-specific topics, such as legal, healthcare, entertainment, software development, finance, etc., depending on the application, along with a corresponding set of values for a plurality of hyper-parameters for each topic. These hyper-parameter values define how the generative AI model 150 should operate for different topics, including controlling the degree of determinism in response generation. In some examples, the configuration file 140 can also include a catch-all topic (e.g., “miscellaneous” or “other”) for user prompts that do not fit into predefined categories. As described herein, the configuration file 140 can be stored in various formats, such as a structured database, a JSON file, a YAML file, a key-value store, a hash table, or the like.

After retrieving the set of values for the plurality of hyper-parameters corresponding to the identified topic, the generative AI agent 120 can send an API request (B) to the generative AI model 150 with the user prompt. The API request can further specify the set of values for the plurality of hyper-parameters. The generative AI model 150 processes the request and generates a response (C) based on the provided hyper-parameter settings. As a result, the generated response aligns with the determinism level appropriate for the identified topic. The generative AI agent 120 then receives the response and presents it back to the user 110 (D), completing the adaptive response generation process.

The administrator 160 can be responsible for maintaining and refining the configuration file 140. In some examples, the administrator 160 can define and update the predefined topics and their corresponding sets of values for the plurality of hyper-parameters based on domain knowledge and system requirements. The administrator 160 can also modify existing entries or add new topics as needed to improve response quality and ensure that the generative AI model 150 produces responses that align with user expectations. In some examples, the administrator 160 can periodically review system performance and user feedback (J) to refine hyper-parameter values, fine-tuning or optimizing the balance between deterministic and non-deterministic behavior. For example, if users consistently report that responses for legal topics lack consistency, the administrator may adjust the hyper-parameters to make outputs more deterministic, or vice versa.

In some implementations, the administrator 160 can also configure selected topics in the configuration file 140 to allow the user 110 to dynamically adjust the values of the hyper-parameters using a feedback mechanism (J). For example, each entry in the configuration file can include a flag indicating whether user adjustments are enabled. If enabled (e.g., by the administrator 160), the user 110 can modify determinism settings using an interactive control, such as a slider, dropdown menu, or other input means. For instance, if the user 110 prefers a more deterministic or creative response (than the initial response produced by the generative AI model 150), the generative AI agent 120 can automatically adjust the set of values for the plurality of hyper-parameters based on predefined mapping functions. As described further below, each hyper-parameter may have a mapping function (e.g., predefined by the administrator 160) that translates the degree of determinism into specific parameter values. On the other hand, the administrator 160 may disable user adjustments of hyper-parameters for some sensitive topics (e.g., legal, compliance-related prompts).

Once the user modifies the determinism setting, the generative AI agent 120 can automatically re-prompt, in runtime, the generative AI model 150 using the adjusted or modified values for the plurality of hyper-parameters to generate a refined response. In some examples, the administrator 160 can further specify how users can adjust the set of values for the plurality of hyper-parameters, e.g., by defining constraints of the mapping functions such as range limits, step sizes, and/or permissible values.

Thus, the framework of FIG. 1 provides a dynamic and context-aware mechanism for adjusting determinism in generative AI models, allowing for precise control over response variability while maintaining user flexibility, administrative oversight, and optimized AI-generated responses across different contexts.

Example Generative AI System with Adaptive Determinism

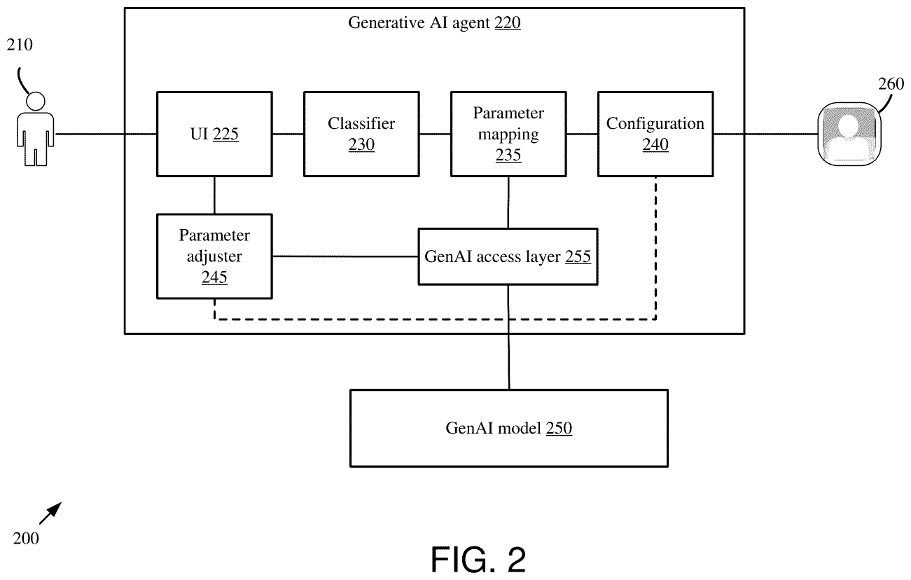

FIG. 2 shows an overall block diagram of an example generative AI system 200 configured to adaptively adjust determinism based on the context of a user's interactions.

As shown, the system 200 includes a generative AI agent 220 and a generative AI model 250. In some examples, the generative AI model 250 can be hosted externally on a third-party platform. In other examples, the generative AI model 250 can be deployed locally (e.g., in the same platform of the generative AI agent 220). The generative AI agent 220 (similar to 120) can be a software module embedded within a software application in a particular domain, such as an enterprise resource planning (ERP) software or the like, providing generative AI support to end users.

In the depicted example, the generative AI agent 220 includes a user interface or UI 225, a classifier 230, a parameter mapping unit 235, a configuration file 240, a parameter adjuster 245, and a generative AI access layer 255. In other examples, some of the components, such as the classifier 230 and/or the configuration file 240, can be external to the generative AI agent 220, similar to those depicted in the framework of FIG. 1.

The UI 225 is configured to receive user input (e.g., user prompt, user feedback, etc.) and display responses generated by the generative AI model 250. When a user 210 submits a user prompt through the UI 225, the classifier 230 (similar to 130) can automatically analyze the user prompt and determines its topic by classifying it into one of a predefined set of topics specified in the configuration file 240 (similar to 140). The parameter mapping unit 235 can then automatically query or lookup the configuration file 240 to retrieve a corresponding set of values for a plurality of hyper-parameters associated with the identified topic. The configuration file 240 can store predefined topics and their corresponding hyper-parameter settings, which can be initially defined and maintained by the administrator 260. In cases where a prompt does not match any predefined topics, a catch-all topic can be applied, which can be associated with default hyper-parameter settings for the generative AI model 250.

The retrieved set of values for the plurality of hyper-parameter, along with the user prompt, can be sent to the generative AI model 250 via the generative AI access layer 255. The generative AI access layer 255 can be configured to act as an interface that enables the generative AI agent 220 to communicate with different generative AI models (e.g., ChatGPT, Gemini, Llama, Claude, BERT, Perplexity, DeepSeek, etc.), supporting multiple APIs for various AI platforms. The response produced by the generative AI model 250 is received by the generative AI access layer 255 and can be presented to the user 210 through the UI 225.

As described above, in some implementations, the administrator 260 can configure selected topics in the configuration file 240 to allow users to adjust the determinism level of responses generated by the generative AI model 250. In such cases, the UI 225 may provide an interactive control, such as a slider, a pair of buttons, or the like, enabling the user 210 to specify a preference for a more deterministic or more creative response. When the user 210 provides such input, the parameter adjuster 245 can automatically modify the set of values for the plurality of hyper-parameters (stored in the configuration file 240) based on predefined mapping functions, which may also be configured by the administrator 260.

Once the parameter adjuster 245 updates the set of values for the plurality of hyper-parameters, the generative AI agent 220 can automatically re-prompt the generative AI model 250 with the original user prompt and the modified set of values for the plurality of hyper-parameters so that the generative AI model 250 can generate an updated response that better aligns with the user's preferences.

The described system 200 can be networked via wired or wireless network connections, including the Internet. Alternatively, the system 200 can be connected through an intranet connection.

The systems 200 and any of the other systems described herein can be implemented in conjunction with any of the hardware components described herein, such as the computing systems described below (e.g., processing units, memory, and the like). In any of the examples herein, user prompt, topics, hyper-parameters and their corresponding values, and the like can be stored in one or more computer-readable storage media or computer-readable storage devices. The technologies described herein can be generic to the specifics of operating systems or hardware and can be applied in any variety of environments to take advantage of the described features.

### Example Transformer Architecture

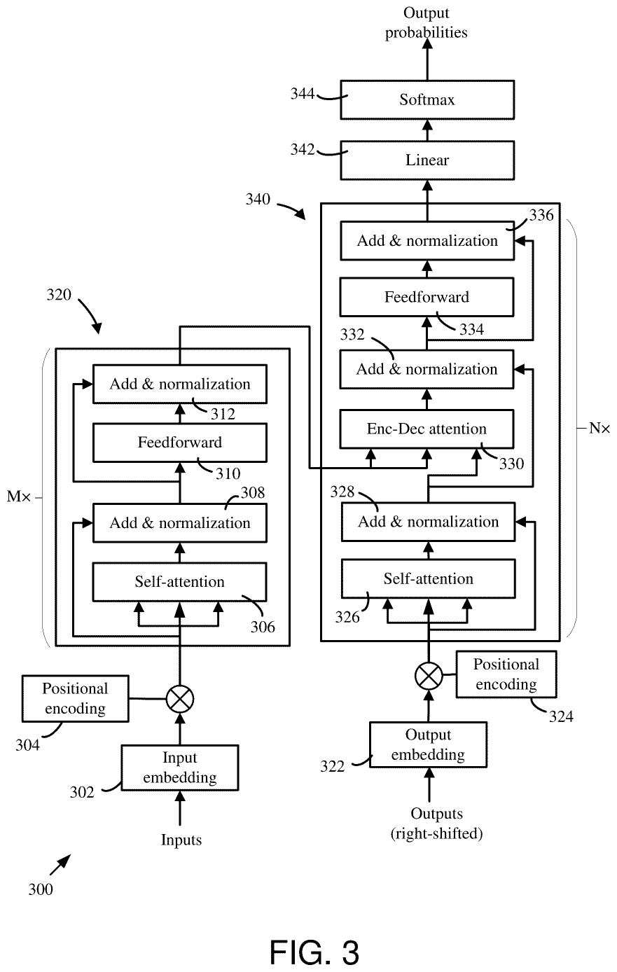

FIG. 3 shows an example architecture of a transformer 300, which can be implemented in any of the generative AI models described herein (e.g., 150, 250).

In the depicted example, the transformer 300 uses an autoregressive model to generate text content by predicting the next token in a sequence given the previous tokens. The transformer 300 can be pre-trained using maximum likelihood estimation to predict each token in the training dataset, given its context. Tokens are the smallest units of text processed by the transformer 300, which can be as short as a single character or as long as part of a word, one word, or multiple words.

As shown in FIG. 3, the transformer 300 can include an encoder 320 and a decoder 340. The encoder 320 processes input text, transforming it into a context-rich representation. The decoder 340 takes this representation and generates text output.

For autoregressive text generation, the transformer 300 generates text in order, relying on preceding tokens for context. During training, the target sequence can be presented to the decoder, right shifted by one position compared to the generated output. This allows the model to predict the next token based on previous tokens.

Text inputs to the encoder 320 represented as tokens can be preprocessed through an input embedding unit 302, which maps each token to a fixed-length vector. Similarly, output sequences can be preprocessed through an output embedding unit 322.

Generally, the vocabulary in transformer 300 is fixed and can be derived from a tokenizer.

In some examples, positional encodings (e.g., 304 and 324) can be added to the input and output embeddings to provide sequential order information. This allows the model to understand the relative positions of tokens in a sentence.

Both the encoder 320 and decoder 340 can include multiple stacked layers (resp. denoted by Mx and Nx in FIG. 3). The number of layers can vary depending on the specific architecture. Generally, a higher “M” or “N” typically means a deeper model, which can capture more complex patterns and dependencies in the data but may require more computational resources for training and inference. The number of stacked layers in the encoder 320 (M) can be the same as, or different from, the number of stacked layers in the decoder 340 (N).

Both the encoder 320 and decoder 340 can include multiple layers of attention and feedforward neural networks. An attention mechanism calculates the relevance of different words or tokens within an input sequence, enabling the model to focus on contextually relevant information. A feedforward neural network processes and transforms this information, applying non-linear transformations to the embeddings.

In the example depicted in FIG. 3, the encoder 320 includes a self-attention neural network 306 and a feedforward neural network 310, while the decoder 340 includes a self-attention neural network 326 and a feedforward neural network 334. The self-attention neural networks 306, 326 allow the transformer 300 to weigh the importance of different words or tokens within the input sequence (encoder 320) or output sequence (decoder 340).

The decoder 340 also includes an encoder-decoder attention neural network 330, which receives input from the encoder 320. This allows the decoder 340 to focus on relevant parts of the input sequence while generating the output sequence. The output of the encoder 320 serves as a continuous representation of the input sequence, which the decoder 340 can use to improve contextual accuracy.

Attention neural networks (e.g., 306, 326, 330) can implement single-head or multi-head attention mechanisms. Single-head attention uses one set of attention weights, while multi-head attention uses multiple sets in parallel to capture different aspects of the input sequence. Multi-head attention may enhance the model's ability to understand complex contexts, leading to more accurate text generation.

Both the encoder 320 and the decoder 340 can include addition and normalization layers (e.g., 308, 312 in the encoder 320; 328, 332, 336 in the decoder 340). Residual connections add the output of a layer to its input, and normalization layers can stabilize the learning process by normalizing features.

A linear layer 342 at the output end of the decoder 340 can transform the output embeddings into the original input space. The output embeddings are forwarded to the linear layer 342, which maps them to a space where each dimension corresponds to a token in the vocabulary of the transformer 300.

The output of the linear layer 342 can be fed to a softmax layer 344, which transforms the logits into probabilities. These probabilities sum to one, with each corresponding to the likelihood of a particular token being the next in the sequence. The token with the highest probability can be selected as the next token in the generated text output.

In some examples, an LLM (e.g., ChatGPT of Open AI, or the like) can include only the decoder, without the encoder, thus it can also be referred to as decoder-only LLM. This configuration can be useful for tasks such as text generation, where the model generates text based on a given prompt. Without the encoder, the LLM relies solely on the decoder to generate text in an autoregressive manner. The encoder-decoder attention neural network (e.g., 330) is removed in this setup, and the LLM uses self-attention neural networks within the decoder to handle context.

Various hyper-parameters can be used to configure the transformer 300, influencing both its training and inference behavior. For example, the number of attention heads can impact how the model captures contextual relationships, while the dropout rate helps prevent overfitting by randomly deactivating neurons during training. As described above, some hyper-parameters, such as temperature and top-k sampling, can affect the degree of determinism in text generation by controlling randomness in token selection.

### Example Overall Method for Implementing Adaptive Determinism for Generative AI

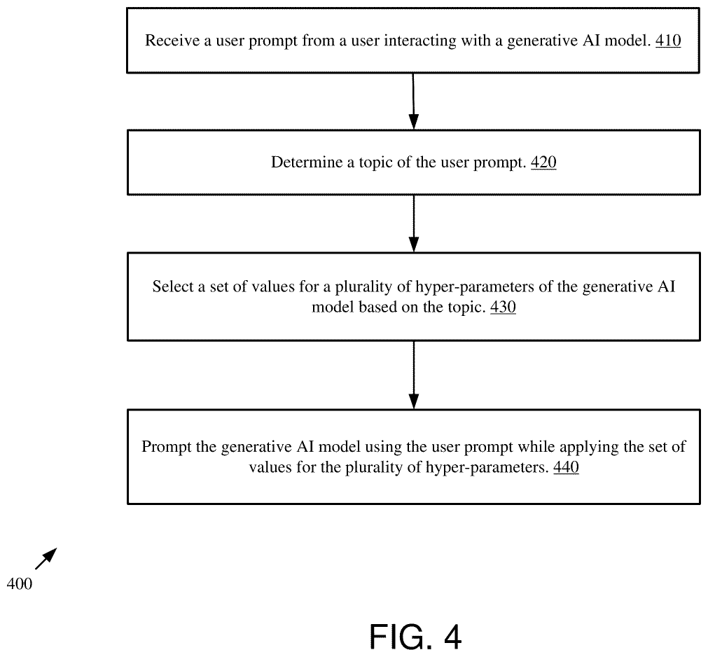

FIG. 4 is a flowchart describing an overall method 400 for performing adaptive determinism for generative AI. The method 400 can be implemented, for example, by the generative AI agent 220 of FIG. 2.

At step 410, the method can receive, from a user interface, a user prompt from a user interacting with a generative AI model;

At step 420, the method can automatically determine, in runtime, a topic of the user prompt.

In some examples, determining the topic of the user prompt includes classifying the user prompt into one of a plurality of predefined topics using natural language processing.

In some examples, classifying the user prompt includes prompting, in runtime, an LLM using a topic prompt. The topic prompt can be configured to instruct the LLM to categorize the user prompt into one of the plurality of predefined topics based on context of the user prompt.

At step 430, the method can automatically select, in runtime, a set of values for a plurality of hyper-parameters of the generative AI model based on the topic of the user prompt. The plurality of hyper-parameters controls a degree of determinism for generating responses based on the user prompt.

Then, at step 440, the method can automatically prompt, in runtime, the generative AI model using the user prompt while applying the set of values for the plurality of hyper-parameters of the generative AI model.

In some examples, selecting the set of values for the plurality of hyper-parameters of the generative AI model includes looking up a configuration file comprising a plurality of predefined topics and respective sets of values for the plurality of hyper-parameters. The set of values can be selected based on matching the topic of the user prompt with one of the predefined topics in the configuration file.

In some examples, the method can further include collecting a feedback from the user on a response generated by the generative AI model in response to the user prompt, and updating the configuration file based at least in part on the feedback. The updating includes changing the set of values for the plurality of hyper-parameters corresponding to the topic of the user prompt.

In some examples, the method can further include receiving an input of the user indicative of a change in the degree of determinism through an interactive control on the user interface, automatically generating, in runtime, a modified set of values for the plurality of hyper-parameters based on the input of the user, and automatically prompting, in runtime, the generative AI model using the user prompt while applying the modified set of values for the plurality of hyper-parameters of the generative AI model.

In some examples, generating the modified set of values includes changing a selected hyper-parameter from a first value to a second value based on a mapping function associated with the selected hyper-parameter. The mapping function adjusts the selected hyper-parameter based on the change in the degree of determinism.

In some examples, the mapping function applies a linear transformation to the selected hyper-parameter such that a difference between the first value and the second value is proportional to the change in the degree of determinism.

In some examples, the mapping function changes the selected hyper-parameter from the first value to the second value responsive to determining that the change in the degree of determinism from the first value exceeds a predefined threshold.

In some examples, the selected hyper-parameter has an allowed data range. The mapping function restricts the second value to a sub-range of the allowed data range.

The method 400 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “send” can also be described as “receive” from a different perspective.

### Example User Adjustment of Hyper-Parameters

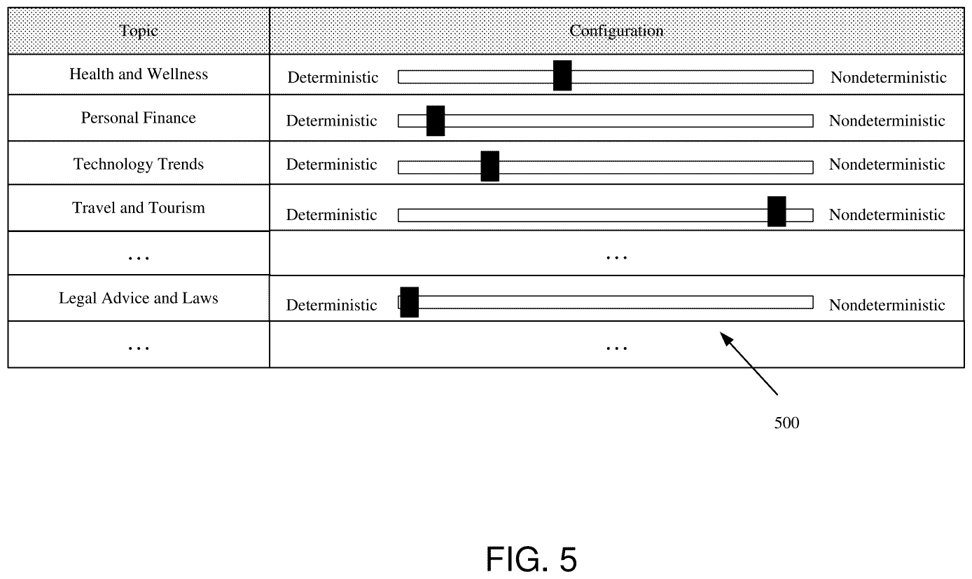

As described above, a user may be allowed to adjust the degree of determinism in responses generated by a generative AI model, provided that such adjustments are enabled by an administrator. If the user finds that the initial response generated by the generative AI model does not exhibit the desired level of determinism, the user can adjust it using an interactive control, such as a slider or scroll bar, as illustrated in FIG. 5. While several example sliders 500 are shown in FIG. 5, other types of controls (such as dropdown menus, buttons, numerical inputs, voice commands, etc.) can also be used.

The position of each slider 500 in FIG. 5 represents a degree of determinism for a corresponding topic, which is determined by the collective effect of all relevant hyper-parameters affecting response variability of the generative AI model. These hyper-parameters, referred to as deterministic-relevant hyper-parameters (DRHPs), are not controlled individually by the user, as the user would have to manage many DRHPs with complex relationships, each influencing different aspects of model behavior. Instead, the user input modifies the overall determinism level, which then translates into adjustments across one or more DRHPs. The set of DRHPs can be generative AI model-specific. Example DRHPs include, but are not limited to temperature, top-p (nucleus sampling), top-k, repetition penalty, do-sample, min_p, etc.

The administrator can predefine the initial set of DRHP values for each topic in a configuration file, which determines the default position of the corresponding slider before any user modification. As illustrated in FIG. 5, different topics can have different predefined degrees of determinism. For example, in the “Legal Advice and Laws” category, the determinism level may be set close to fully deterministic, whereas for the “Health and Wellness” topic, a more balanced or non-deterministic default setting may be used to allow for diverse responses.

When the user moves the slider toward a more deterministic or non-deterministic setting, the system can automatically adjust (e.g., using the parameter adjuster 245) one or more DRHPs accordingly. Depending on the topic, the adjustment may affect one, a subset, or all DRHPs at once. Depending on implementation, the user input can cause a stepwise increase or decrease in the degree of determinism, where the step size can be predefined by the administrator, or it can directly set the determinism level to a specific desired value.

### Example Mapping Functions

In some implementations, the degree of determinism can be defined within a normalized range or spectrum, such as 0 to 100 or the like, where 0 represents a completely deterministic response and 100 represents maximum randomness (alternative range definitions can also be used). Each hyper-parameter affecting determinism or DRHP can have an associated mapping function, which defines how its value changes in response to the user input. These mapping functions can be configured by the administrator. For each topic, the mapping functions for two different DRHPs can be the same or different. For two different topics, the mapping functions for the same DRHP can also be the same or different.

For instance, for the top-p sampling hyper-parameter (which controls the probability mass used in response generation, restricting token selection to the most probable subset), a linear mapping function can be defined as:

$$top - p = \frac{d}{R}$$

Here, d represents the user-defined determinism level, and R represents the full range of the spectrum (e.g., 0-100). In this case, top-p would scale linearly from 0 (fully deterministic) to 1 (completely non-deterministic), with user adjustments shifting the value accordingly.

As another example, the do-sample hyper-parameter is a Boolean parameter that determines whether token sampling should be applied or if the generative AI model should always choose the most probable next token. A threshold function can be applied such that:

$$do - sample = \{ \begin{matrix}TRUE & if d \geq TH \\ FALSE & otherwise\end{matrix}$$

In this case, when d is below a predefined threshold TH (e.g., 10), do-sample is set to FALSE, ensuring strict determinism. Otherwise, it remains TRUE, allowing sampling to introduce variability.

As another example, for top-k sampling (which limits the model's token selection to the k most probable choices at each step), both a linear mapping and a threshold-based function can be used. For instance:

$$top - k = \{ \begin{matrix}1 & if d < TH \\ d & otherwise\end{matrix}$$

This means that for low d values (e.g., below a threshold TH), top-k is fixed at 1 (forcing strict determinism), while for higher values, it scales linearly based on d.

In some implementations, non-linear mapping functions may be used. For example, a logarithmic function could be used to sharply increase “temperature” at lower d values and gradually flatten out at higher d values:

$$temperature = log ( 1 + d ) / log ( 1 + R )$$

This allows for a more rapid adjustment of randomness at lower determinism levels while ensuring a more controlled increase in randomness at higher determinism levels.

It should be understood that the example mapping functions described herein are merely illustrative and not limiting.

In some examples, to maintain control over model behavior, the administrator can also restrict user adjustments by setting value limits on d for certain topics. For instance, in “Legal Advice and Laws,” where strict determinism is preferred, the administrator may restrict d to range only between 0 and 5, rather than 0 to 100. These topic-based restrictions can be enforced by mapping the limited range of d to an equivalent restricted range for each DRHP, ensuring that user modifications remain within acceptable bounds.

### Example Advantages

As described above, generative AI faces challenges in balancing determinism and randomness. Conventional techniques rely on manual adjustment of hyper-parameter settings which is inefficient and lacks contextual awareness. The technologies described herein offer several technical advantages over existing approaches.

Thee disclosed technologies introduce an adaptive determinism framework that dynamically classifies user prompts into a predefined topic, retrieves topic-specific hyper-parameter values, and automatically applies them to the generative AI model. This ensures the generative AI's response behavior aligns with the context of the user prompt, without requiring any user intervention, improving not only efficiency and efficacy but also user experience.

Moreover, the disclosed technologies enable flexible user adjustment to fine-tune deterministic behavior for selected topics. Instead of manually configuring multiple hyper-parameters, users can adjust a single control to modify the degree of determinism. The user input can be mapped to coordinated changes across multiple hyper-parameters, ensuring smooth and intuitive adjustments. This feature provides greater flexibility by allowing users to refine AI responses in real time when default settings do not align with expectations.

Further, the usage of configuration file enhances flexibility and scalability by allowing administrators to predefine topic-specific hyper-parameters and set constraints on user adjustments. By default, the framework establishes deterministic settings for all desired topics as defined by administrators from the outset, ensuring high determinism for certain critical topics while allowing greater variability for other creative topics. User configuration is optional-if users wish to further fine-tune determinism beyond the predefined settings, they can do so seamlessly. This modular design enables easy adaptation across different generative AI models without modifying the adaptive determinism framework, thereby providing a scalable and configurable solution for diverse applications.

### Example Computing Systems

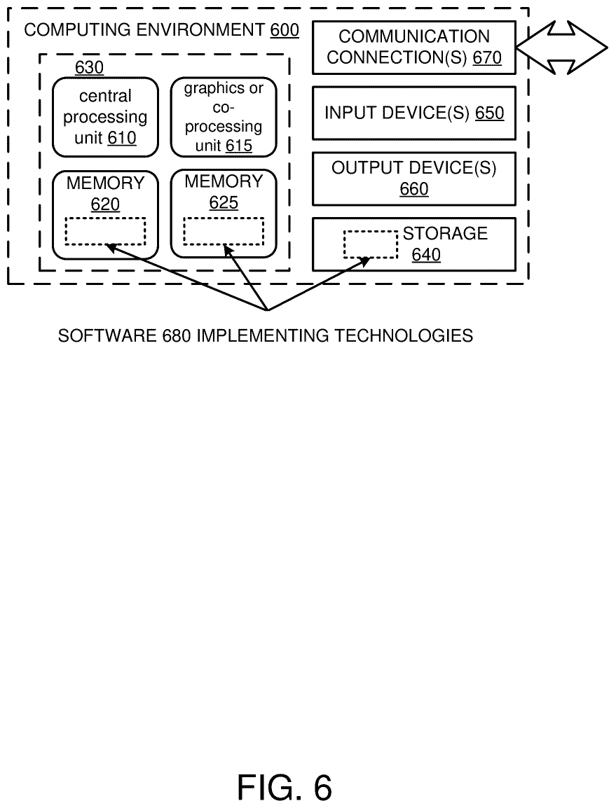

FIG. 6 depicts an example of a suitable computing system 600 in which the described innovations can be implemented. The computing system 600 is not intended to suggest any limitation as to scope of use or functionality of the present disclosure, as the innovations can be implemented in diverse computing systems.

With reference to FIG. 6, the computing system 600 includes one or more processing units 610, 615 and memory 620, 625. In FIG. 6, this basic configuration 630 is included within a dashed line. The processing units 610, 615 can execute computer-executable instructions, such as for implementing the features described in the examples herein (e.g., the method 400). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 6 shows a central processing unit 610 as well as a graphics processing unit or co-processing unit 615. The tangible memory 620, 625 can be volatile memory (e.g., registers, cache, RAM), non-volatile memory (e.g., ROM, EEPROM, flash memory, etc.), or some combination of the two, accessible by the processing unit(s) 610, 615. The memory 620, 625 can store software 680 implementing one or more innovations described herein, in the form of computer-executable instructions suitable for execution by the processing unit(s) 610, 615.

A computing system 600 can have additional features. For example, the computing system 600 can include storage 640, one or more input devices 650, one or more output devices 660, and one or more communication connections 670, including input devices, output devices, and communication connections for interacting with a user. An interconnection mechanism (not shown) such as a bus, controller, or network can interconnect the components of the computing system 600. Typically, operating system software (not shown) can provide an operating environment for other software executing in the computing system 600, and coordinate activities of the components of the computing system 600.

The tangible storage 640 can be removable or non-removable, and includes magnetic disks, magnetic tapes or cassettes, CD-ROMs, DVDs, or any other medium which can be used to store information in a non-transitory way and which can be accessed within the computing system 600. The storage 640 can store instructions for the software implementing one or more innovations described herein.

The input device(s) 650 can be an input device such as a keyboard, mouse, pen, or trackball, a voice input device, a scanning device, touch device (e.g., touchpad, display, or the like) or another device that provides input to the computing system 600. The output device(s) 660 can be a display, printer, speaker, CD-writer, or another device that provides output from the computing system 600.

The communication connection(s) 670 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example Cloud Computing Environment

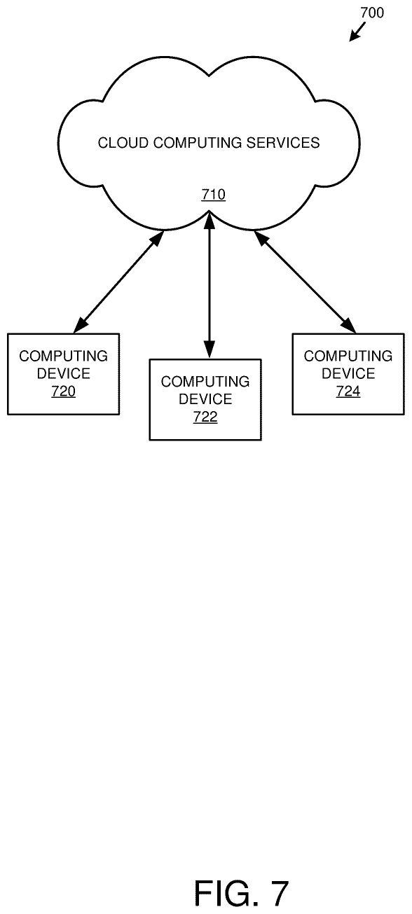

FIG. 7 depicts an example cloud computing environment 700 in which the described technologies can be implemented, including, e.g., the system 200 and other systems herein. The cloud computing environment 700 can include cloud computing services 710. The cloud computing services 710 can comprise various types of cloud computing resources, such as computer servers, data storage repositories, networking resources, etc. The cloud computing services 710 can be centrally located (e.g., provided by a data center of a business or organization) or distributed (e.g., provided by various computing resources located at different locations, such as different data centers and/or located in different cities or countries).

The cloud computing services 710 can be utilized by various types of computing devices (e.g., client computing devices), such as computing devices 720, 722, and 724. For example, the computing devices (e.g., 720, 722, and 724) can be computers (e.g., desktop or laptop computers), mobile devices (e.g., tablet computers or smart phones), or other types of computing devices. For example, the computing devices (e.g., 720, 722, and 724) can utilize the cloud computing services 710 to perform computing operations (e.g., data processing, data storage, and the like).

In practice, cloud-based, on-premises-based, or hybrid scenarios can be supported.

### Example Implementations

In any of the examples herein, a software application (or “application”) can take the form of a single application or a suite of a plurality of applications, whether offered as a service (SaaS), in the cloud, on premises, on a desktop, mobile device, wearable, or the like.

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

In any of the examples described herein, an operation performed in runtime or real-time means that the operation can be completed with negligible processing latency (e.g., the operation can be completed within 1 second, etc.).

### Example Clauses

Any of the following clauses can be implemented.

Clause 1. A computing system comprising: memory; one or more hardware processors coupled to the memory; and one or more non-transitory computer readable storage media storing instructions that, when loaded into the memory, cause the one or more hardware processors to perform operations comprising: receiving, from a user interface, a user prompt from a user interacting with a generative artificial intelligence (AI) model; determining, in runtime, a topic of the user prompt; selecting, in runtime, a set of values for a plurality of hyper-parameters of the generative AI model based on the topic of the user prompt, wherein the plurality of hyper-parameters controls a degree of determinism for generating responses based on the user prompt; and prompting, in runtime, the generative AI model using the user prompt while applying the set of values for the plurality of hyper-parameters of the generative AI model.

Clause 2. The computing system of clause 1, wherein determining the topic of the user prompt comprises classifying the user prompt into one of a plurality of predefined topics using natural language processing.

Clause 3. The computing system of clause 2, wherein classifying the user prompt comprises prompting, in runtime, a large language model using a topic prompt, wherein the topic prompt is configured to instruct the large language model to categorize the user prompt into one of the plurality of predefined topics based on context of the user prompt.

Clause 4. The computing system of any one of clauses 1-3, wherein selecting the set of values for the plurality of hyper-parameters of the generative AI model comprises looking up a configuration file comprising a plurality of predefined topics and respective sets of values for the plurality of hyper-parameters, wherein the set of values is selected based on matching the topic of the user prompt with one of the predefined topics in the configuration file.

Clause 5. The computing system of clause 4, wherein the operations further comprise: collecting a feedback from the user on a response generated by the generative AI model in response to the user prompt; and updating the configuration file based at least in part on the feedback, wherein the updating comprises changing the set of values for the plurality of hyper-parameters corresponding to the topic of the user prompt.

Clause 6. The computing system of any one of clauses 1-5, wherein the operations further comprise: receiving an input of the user through an interactive control on the user interface, wherein the input indicates a change in the degree of determinism; generating, in runtime, a modified set of values for the plurality of hyper-parameters based on the input of the user; and prompting, in runtime, the generative AI model using the user prompt while applying the modified set of values for the plurality of hyper-parameters of the generative AI model.

Clause 7. The computing system of clause 6, wherein generating the modified set of values comprises changing a selected hyper-parameter from a first value to a second value based on a mapping function associated with the selected hyper-parameter, wherein the mapping function adjusts the selected hyper-parameter based on the change in the degree of determinism.

Clause 8. The computing system of clause 7, wherein the mapping function applies a linear transformation to the selected hyper-parameter such that a difference between the first value and the second value is proportional to the change in the degree of determinism.

Clause 9. The computing system of clause 7, wherein the mapping function changes the selected hyper-parameter from the first value to the second value responsive to determining that the change in the degree of determinism from the first value exceeds a predefined threshold.

Clause 10. The computing system of any one of clauses 7-9, wherein the selected hyper-parameter has an allowed data range, wherein the mapping function restricts the second value to a sub-range of the allowed data range.

Clause 11. A computer-implemented method comprising: receiving, from a user interface, a user prompt from a user interacting with a generative artificial intelligence (AI) model; determining, in runtime, a topic of the user prompt; selecting, in runtime, a set of values for a plurality of hyper-parameters of the generative AI model based on the topic of the user prompt, wherein the plurality of hyper-parameters controls a degree of determinism for generating responses based on the user prompt; and prompting, in runtime, the generative AI model using the user prompt while applying the set of values for the plurality of hyper-parameters of the generative AI model.

Clause 12. The computer-implemented method of clause 11, wherein determining the topic of the user prompt comprises classifying the user prompt into one of a plurality of predefined topics using natural language processing.

Clause 13. The computer-implemented method of clause 12, wherein classifying the user prompt comprises prompting, in runtime, a large language model using a topic prompt, wherein the topic prompt is configured to instruct the large language model to categorize the user prompt into one of the plurality of predefined topics based on context of the user prompt.

Clause 14. The computer-implemented method of any one of clauses 11-13, wherein selecting the set of values for the plurality of hyper-parameters of the generative AI model comprises looking up a configuration file comprising a plurality of predefined topics and respective sets of values for the plurality of hyper-parameters, wherein the set of values is selected based on matching the topic of the user prompt with one of the predefined topics in the configuration file.

Clause 15. The computer-implemented method of clause 14, further comprising: collecting a feedback from the user on a response generated by the generative AI model in response to the user prompt; and updating the configuration file based at least in part on the feedback, wherein the updating comprises changing the set of values for the plurality of hyper-parameters corresponding to the topic of the user prompt.

Clause 16. The computer-implemented method of any one of clauses 11-15, further comprising: receiving an input of the user through an interactive control on the user interface, wherein the input indicates a change in the degree of determinism; generating, in runtime, a modified set of values for the plurality of hyper-parameters based on the input of the user; and prompting, in runtime, the generative AI model using the user prompt while applying the modified set of values for the plurality of hyper-parameters of the generative AI model.

Clause 17. The computer-implemented method of clause 16, wherein generating the modified set of values comprises changing a selected hyper-parameter from a first value to a second value based on a mapping function associated with the selected hyper-parameter, wherein the mapping function adjusts the selected hyper-parameter based on the change in the degree of determinism.

Clause 18. The computer-implemented method of clause 17, wherein the selected hyper-parameter has a numerical data type, and the mapping function applies a linear transformation to the selected hyper-parameter such that a difference between the first value and the second value is proportional to the change in the degree of determinism.

Clause 19. The computer-implemented method of clause 17, wherein the selected hyper-parameter has a Boolean data type, and the mapping function changes the selected hyper-parameter from the first value to the second value responsive to determining that the change in the degree of determinism from the first value exceeds a predefined threshold.

Clause 20. One or more non-transitory computer-readable media having encoded thereon computer-executable instructions causing one or more processors to perform a method, the method comprising: receiving, from a user interface, a user prompt from a user interacting with a generative artificial intelligence (AI) model; determining, in runtime, a topic of the user prompt; selecting, in runtime, a set of values for a plurality of hyper-parameters of the generative AI model based on the topic of the user prompt, wherein the plurality of hyper-parameters controls a degree of determinism for generating responses based on the user prompt; and prompting, in runtime, the generative AI model using the user prompt while applying the set of values for the plurality of hyper-parameters of the generative AI model.

The technologies from any clause can be combined with the technologies described in any one or more of the other clauses.

In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
memory;
one or more hardware processors coupled to the memory; and
one or more non-transitory computer readable storage media storing instructions that, when loaded into the memory, cause the one or more hardware processors to perform operations comprising:
receiving, from a user interface, a user prompt from a user interacting with a generative artificial intelligence (AI) model;
determining, in runtime, a topic of the user prompt;
selecting, in runtime, a set of values for a plurality of hyper-parameters of the generative AI model based on the topic of the user prompt, wherein the plurality of hyper-parameters controls a degree of determinism for generating responses based on the user prompt; and
prompting, in runtime, the generative AI model using the user prompt while applying the set of values for the plurality of hyper-parameters of the generative AI model.

2. The computing system of claim 1, wherein determining the topic of the user prompt comprises classifying the user prompt into one of a plurality of predefined topics using natural language processing.

3. The computing system of claim 2, wherein classifying the user prompt comprises prompting, in runtime, a large language model using a topic prompt, wherein the topic prompt is configured to instruct the large language model to categorize the user prompt into one of the plurality of predefined topics based on context of the user prompt.

4. The computing system of claim 1, wherein selecting the set of values for the plurality of hyper-parameters of the generative AI model comprises looking up a configuration file comprising a plurality of predefined topics and respective sets of values for the plurality of hyper-parameters, wherein the set of values is selected based on matching the topic of the user prompt with one of the predefined topics in the configuration file.

5. The computing system of claim 4, wherein the operations further comprise:
collecting a feedback from the user on a response generated by the generative AI model in response to the user prompt; and
updating the configuration file based at least in part on the feedback, wherein the updating comprises changing the set of values for the plurality of hyper-parameters corresponding to the topic of the user prompt.

6. The computing system of claim 1, wherein the operations further comprise:
receiving an input of the user through an interactive control on the user interface, wherein the input indicates a change in the degree of determinism;
generating, in runtime, a modified set of values for the plurality of hyper-parameters based on the input of the user; and
prompting, in runtime, the generative AI model using the user prompt while applying the modified set of values for the plurality of hyper-parameters of the generative AI model.

7. The computing system of claim 6, wherein generating the modified set of values comprises changing a selected hyper-parameter from a first value to a second value based on a mapping function associated with the selected hyper-parameter, wherein the mapping function adjusts the selected hyper-parameter based on the change in the degree of determinism.

8. The computing system of claim 7, wherein the mapping function applies a linear transformation to the selected hyper-parameter such that a difference between the first value and the second value is proportional to the change in the degree of determinism.

9. The computing system of claim 7, wherein the mapping function changes the selected hyper-parameter from the first value to the second value responsive to determining that the change in the degree of determinism from the first value exceeds a predefined threshold.

10. The computing system of claim 7, wherein the selected hyper-parameter has an allowed data range, wherein the mapping function restricts the second value to a sub-range of the allowed data range.

11. A computer-implemented method comprising:
receiving, from a user interface, a user prompt from a user interacting with a generative artificial intelligence (AI) model;
determining, in runtime, a topic of the user prompt;
selecting, in runtime, a set of values for a plurality of hyper-parameters of the generative AI model based on the topic of the user prompt, wherein the plurality of hyper-parameters controls a degree of determinism for generating responses based on the user prompt; and
prompting, in runtime, the generative AI model using the user prompt while applying the set of values for the plurality of hyper-parameters of the generative AI model.

12. The computer-implemented method of claim 11, wherein determining the topic of the user prompt comprises classifying the user prompt into one of a plurality of predefined topics using natural language processing.

13. The computer-implemented method of claim 12, wherein classifying the user prompt comprises prompting, in runtime, a large language model using a topic prompt, wherein the topic prompt is configured to instruct the large language model to categorize the user prompt into one of the plurality of predefined topics based on context of the user prompt.

14. The computer-implemented method of claim 11, wherein selecting the set of values for the plurality of hyper-parameters of the generative AI model comprises looking up a configuration file comprising a plurality of predefined topics and respective sets of values for the plurality of hyper-parameters, wherein the set of values is selected based on matching the topic of the user prompt with one of the predefined topics in the configuration file.

15. The computer-implemented method of claim 14, further comprising:
collecting a feedback from the user on a response generated by the generative AI model in response to the user prompt; and
updating the configuration file based at least in part on the feedback, wherein the updating comprises changing the set of values for the plurality of hyper-parameters corresponding to the topic of the user prompt.

16. The computer-implemented method of claim 11, further comprising:
receiving an input of the user through an interactive control on the user interface, wherein the input indicates a change in the degree of determinism;
generating, in runtime, a modified set of values for the plurality of hyper-parameters based on the input of the user; and
prompting, in runtime, the generative AI model using the user prompt while applying the modified set of values for the plurality of hyper-parameters of the generative AI model.

17. The computer-implemented method of claim 16, wherein generating the modified set of values comprises changing a selected hyper-parameter from a first value to a second value based on a mapping function associated with the selected hyper-parameter, wherein the mapping function adjusts the selected hyper-parameter based on the change in the degree of determinism.

18. The computer-implemented method of claim 17, wherein the mapping function applies a linear transformation to the selected hyper-parameter such that a difference between the first value and the second value is proportional to the change in the degree of determinism.

19. The computer-implemented method of claim 17, wherein the mapping function changes the selected hyper-parameter from the first value to the second value responsive to determining that the change in the degree of determinism from the first value exceeds a predefined threshold.

20. One or more non-transitory computer-readable media having encoded thereon computer-executable instructions causing one or more processors to perform a method, the method comprising:
receiving, from a user interface, a user prompt from a user interacting with a generative artificial intelligence (AI) model;
determining, in runtime, a topic of the user prompt;
selecting, in runtime, a set of values for a plurality of hyper-parameters of the generative AI model based on the topic of the user prompt, wherein the plurality of hyper-parameters controls a degree of determinism for generating responses based on the user prompt; and
prompting, in runtime, the generative AI model using the user prompt while applying the set of values for the plurality of hyper-parameters of the generative AI model.
